(19) United States
(12) Patent Application Publication
(10) Pub. No.: US 2022/0150143 A1
(43) Pub. Date: May 12, 2022

(54) CLASSIFICATION OF ENCRYPTED INTERNET TRAFFIC WITH BINARY TRAFFIC VECTORS

(71) Applicant: AT&T Intellectual Property I, L.P., Atlanta, GA (US)

(72) Inventors: Zhengye Liu, Pleasanton, CA (US); Jin Wang, Fremont, CA (US); Donglin Hu, Dublin, CA (US)

(21) Appl. No.: 17/096,522

(22) Filed: Nov. 12, 2020

(51) Int. Cl. H04L 12/26; H04L 12/717; H04L 29/08; H04L 29/06; G06N 3/04; G06N 3/08

(52) U.S. Cl. CPC H04L 43/062; H04L 43/0888; H04L 45/42; G06N 3/08; H04L 69/164; G06N 3/04; H04L 69/326

(57) ABSTRACT

A processing system including at least one processor may generate a binary traffic vector from a traffic flow in a communication network. The binary traffic vector may comprise a plurality of elements, each associated with a respective time period and comprising one of: a first value or a second value. For each time period the traffic flow comprises a transfer of a data unit, a corresponding element comprises the first value, and for time period the traffic flow does not comprise a transfer of a data unit, a corresponding element comprises the second value. The processing system may then apply a traffic flow record comprising the binary traffic vector as an input to a deep learning classifier trained to classify traffic flow records into traffic categories, and determine a traffic category from an output of the deep learning classifier in accordance with the traffic flow record as the input.

The present disclosure relates generally to data traffic flow classification, and relates more particularly to methods, non-transitory computer-readable media, and apparatuses for determining a traffic category via a deep learning classifier based upon a traffic vector generated from a traffic flow.

### BACKGROUND

Network traffic classification categorizes packets or traffic flows into a plurality of classes. For instance, different classes may be defined for Internet traffic associated with online gaming, video streaming, email, voice calling (e.g., Voice over Internet Protocol or VoIP), and the like. Each class of traffic may require a different Quality of Experience (QoE). Thus, higher priority classes of traffic demanding greater QoE may be allocated more network resources (e.g., more bandwidth) than other classes. As such, being able to accurately classify Internet traffic is vital to helping Internet service providers optimize their networks to achieve optimal QoE with limited network resources.

### BRIEF DESCRIPTION OF THE DRAWINGS

The teachings of the present disclosure can be readily understood by considering the following detailed description in conjunction with the accompanying drawings, in which:

FIG. 1 illustrates an example network related to the present disclosure;

FIG. 2 illustrates a graph of a representative traffic pattern of an example streaming video and a corresponding example binary traffic vector, in accordance with the present disclosure;

FIG. 3 illustrates an example architecture of a convolutional neural network-based deep learning classifier, in accordance with the present disclosure;

FIG. 4 illustrates a flowchart of an example method for determining a traffic category via a deep learning classifier based upon a traffic vector generated from a traffic flow in accordance with the present disclosure; and

FIG. 5 depicts a high-level block diagram of a computing device, or computing system specifically programmed to perform the steps, functions, blocks and/or operations described herein.

To facilitate understanding, identical reference numerals have been used, where possible, to designate identical elements that are common to the figures.

### DETAILED DESCRIPTION

In one example, the present disclosure describes a method, computer-readable medium, and apparatus for determining a traffic category via a deep learning classifier based upon a traffic vector generated from a traffic flow. For instance, in one example, a processing system including at least one processor may generate a binary traffic vector from a first traffic flow in a communication network. For instance, the binary traffic vector may comprise a plurality of elements, each of the plurality of elements associated with a respective time period, each of the plurality of elements comprising one of: a first value or a second value, where for each respective time period for which the first traffic flow comprises a transfer of at least one data unit, a corresponding element of the plurality of elements comprises the first value, and where for each respective time period for which the first traffic flow does not comprise a transfer of at least one data unit, a corresponding element of the plurality of elements comprises the second value. The processing system may then apply a first traffic flow record comprising the binary traffic vector as an input to a deep learning classifier that is trained to classify traffic flow records into one of a plurality of traffic categories, and determine a traffic category of the first traffic flow, from among the plurality of traffic categories, from an output of the deep learning classifier in accordance with the first traffic flow record as the input to the deep learning classifier.

In accordance with the present disclosure, different classes may be defined for data traffic (e.g., Internet traffic) associated with: streaming video, streaming audio, conversational video, conversational audio, gaming, and other traffic. Each class of traffic may require a different Quality of Experience (QoE). Thus, higher priority classes of data traffic demanding greater QoE may be allocated more network resources (e.g., more bandwidth, differentiated routing, etc.) than other classes for which the required QoE is lower. For example, streaming video may require a relatively high resolution and smooth playback, while latency is less critical (in several to tens of seconds range). On the other hand, conversational video may have a stringent latency requirement (e.g., in a hundreds of milliseconds range), but lower resolution and video bitrate may be acceptable. Thus, being able to accurately classify data traffic is important in helping communication network service providers optimize their networks to achieve optimal QoE with limited network resources. This is especially true for video and non-video traffic classes, since video traffic typically consumes a great deal more resources than non-video traffic.

However, as encrypted communication protocols such as hypertext transfer protocol secure (HTTPS) and QUIC (also referred to herein as “quic”) become more widely used, it becomes more difficult to accurately classify data traffic (e.g., in packet-based networks). For instance, traditional traffic classification techniques such as deep packet inspection (DPI) are less effective, since the data that is typically inspected to determine traffic type (e.g., network signatures, HTTP headers, etc.) is no longer visible. In addition, Server Name Indication (SNI) information may increasingly become unavailable. In particular, in current HTTPS implementations, although traffic content is encrypted, SNI is still available. SNI indicates the domain name of a service provider, which can be linked to which type of service it provides. Thus, SNI can be used in conventional DPI approaches for data traffic classification. However, multiple proposals have been offered to encrypt SNI (so-called eSNI), where SNI is no longer visible by DPI.

In addition to encrypted data traffic, there is a trend for application service providers to deliver mixed traffic. For example, a single provider may offer both video streaming and audio (music) streaming services from the same servers. Similarly, a single service provider may offer image sharing and video sharing via the same servers. Thus, in many cases a single SNI can be used to serve different types of data traffic. Therefore, even by assuming that SNI is available, DPI may be unable to differentiate multiple services by investigating a single SNI. Mixed traffic is especially common when public cloud deployments and content distribution networks (CDNs) are involved. Commonly, cloud service providers and CDNs host and provide diverse services, such that the data traffic is naturally mixed. With the above challenges, DPI approaches may no longer be valid options for accurate network traffic classification.

In one example, the present disclosure provides a single deep-learning model with a single iteration that can classify network traffic flows (or “data traffic flows”) into traffic categories (e.g., one of six categories), while achieving a high classification accuracy. For instance, a single iteration in accordance with examples of the present disclosure may achieve classification accuracy of 90% or greater. In one example, the present disclosure directly uses a traffic pattern, e.g., a binary traffic vector, to classify network traffic flows. For instance, a traffic pattern is fundamental to a specific type of data service. It is jointly determined by network architecture, transmission protocol, service requirements, etc. Different traffic flows of a same type of data service, such as streaming video, shares a common traffic pattern, while different types of data services, such as streaming video vs. streaming audio, present different traffic patterns. Therefore, classifying a type of data service is thus converted to classifying a type of traffic pattern. For example, chunk-based video transmission is currently dominating video delivery. Thus, most providers are using similar approaches which exhibit similar patterns. For instance, video chunks may result in a spike in data traffic for a chunk, then idle time after the chunk before transmitting the next chunk. In contrast, conversational video uses different protocol(s) and exhibits different patterns. For instance, there are no spikes in data traffic and then idle time because this would affect the latency of a real-time conversation. Whereas for chunk-based video delivery, even so call live streams operate with some delay from “real time,” and thus can pre-deliver content before it is presented and tolerate some idle time in the transmission.

In one example, the present disclosure first pre-processes a traffic flow to describe a traffic pattern. For example, a traffic flow, or traffic session may be segmented into multiple records, e.g., of 60-minute duration. In one example, each record may comprise at least one binary traffic vector (or a “bit vector”), or at least a portion thereof (e.g., a “sub-vector”) that indicates if there is any packet transmitted within a given time period (also referred to a time block, or time slot). For instance, each bit of the at least one binary traffic vector may correspond to a one second time slot/time block. In one example, for each one second time slot, if there is at least one packet transmitted, the according bit in the binary traffic vector may be set to “1;” otherwise, the bit may be set to “0.” In another example, the convention may be reversed (e.g., zero (0) for the presence of at least one packet, one (1) for the absence of any packets). In one example, each record may be broken into multiple sub-vectors, e.g., one-minute binary traffic vectors, 30-second binary traffic vectors, or the like. In addition, an overall traffic flow may be represented by any number of records (e.g., for a traffic flow greater than 60 minutes duration, where records are for at most 60 minutes of duration). Thus, in one example, a binary traffic vector may be spread over a number of sub-vectors and over a number of records. It should also be noted that for shorter traffic flows, binary traffic vectors for multiple traffic flows may be combined into a single record, e.g., for convenience of storage and/or retrieval.

In one example, packets may be assigned to traffic flows based upon a 5-tuple comprising a source Internet Protocol (IP) address, a destination IP address, a source port, a destination port, and a transport layer protocol. In an example where port information is not available, packets may be assigned to traffic flows based upon: source IP address and destination IP address, or source IP address, destination IP address, and transport layer protocol. In one example, the assigning of packets to traffic flows may also account for the timing of packet arrival. For instance, a packet having a particular 5-tuple that is the same as a last seen packet with the same 5-tuple, may be assigned to the same traffic flow if the inter-arrival time is below a threshold period of time (e.g., within 5 minutes, within 10 minutes, etc.), but may be considered to be a new traffic flow if the inter-arrival time is at or over the threshold period of time.

In one example, packets may be observed and assigned to traffic flows at a network firewall and/or an ingress/egress node (broadly “network nodes”) of a communication network (e.g., a provider edge (PE) router, or the like). In one example, packets may be mirrored/coped at such network nodes (and/or by network probes) and provided to another network-based processing system for further processing in accordance with the present disclosure. In another example, aggregate information of traffic flows (e.g., on a per-traffic flow basis) may be gathered at such nodes and provided to one or more other processing systems for further processing in accordance with the present disclosure. In still another example, traffic flow classification may be performed on a per-network node basis. For instance, for each network firewall or other network node implementing examples of the present disclosure, such network node may be responsible for classifying the traffic flows processed at such network node.

In addition to a binary traffic vector, in one example, traffic flows may be further characterized by one or two flow-level parameters including the transport layer protocol (e.g., Uniform Datagram Protocol (UDP) versus Transport Control Protocol (TCP)) and/or a throughput (e.g., an average throughput or average bitrate over the entire traffic flow). Notably, the transport layer protocol and average throughput may still be available, regardless of whether packets are encrypted, and regardless of whether SNI is available. In one example, either or both of these parameters may be utilized in conjunction with the at least one binary traffic vector as input(s) to a deep learning classifier in accordance with the present disclosure. It should also be noted that in other, further, and different examples, a different arrangement may be used to characterize a traffic flow. For instance, a ternary or quaternary vector may be used, instead of a binary traffic vector. For example, there may be three categorizes for each time interval (e.g., each one second interval), such as zero (0) for no packets, one (1) for a number of packets above 2×10⁶, and (2) for a number of packets equal to or greater than 2×10⁶. However, in any case, the representation of the traffic pattern is not merely the instantaneous bitrate, but is intended to be a much simplified representation of the level of traffic, e.g., at most using 10 levels to indicate the possible traffic volume in any given time slot.

In accordance with the present disclosure, traffic flows may be represented by the above information (e.g., a binary traffic vector, and in one example a transport layer protocol and/or an average throughput). In addition, in one example, a deep learning classifier is designed and trained to take such traffic flow information as inputs, and to output a traffic classification (e.g., one of six traffic categories) for each traffic flow. In one example, the deep learning classifier comprises a convolutional neural network (CNN). For instance, in one example, the CNN may comprise a WaveNet. In another example, the CNN may comprise an AlexNet. For example, the use of a binary/bit vector enables pattern classification models that are generally suited for image and/or audio classification to be utilized in traffic classification. In addition, with these features, the implementation, updating, and maintaining of such a classifier is improved. In particular, training time of the deep learning classifier may be shortened, while at the same time high accuracy may be achieved with single iteration processing.

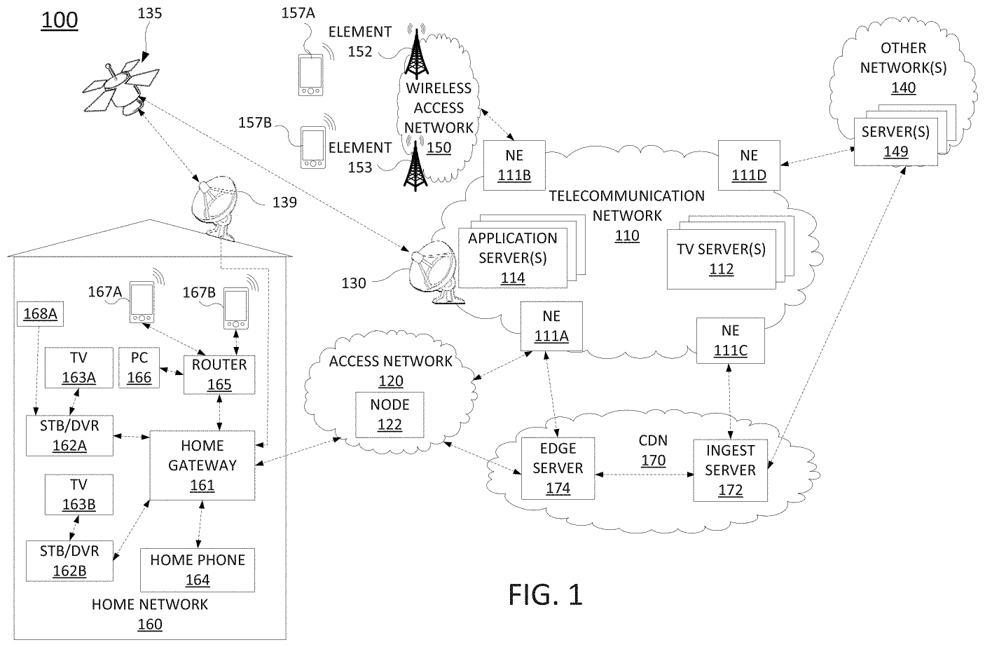

In one example, at least one binary traffic vector of a traffic flow may be input to a plurality of layers of the deep learning classifier comprising a deep neural network. A concatenate layer may join the output of the deep neural network with the additional input(s) of the transport layer protocol and/or the average throughput. One or more fully-connected layers may follow the concatenate layer. Lastly, an output layer coupled to the fully-connected layer(s) may provide outputs comprising values/scores for each possible traffic categories (e.g., six traffic categories, such as noted above). For instance, each value/score may provide a relative likelihood or confidence that a particular traffic flow belongs/does not belong to each category. For example, a highest score/value may indicate that a traffic flow most likely is of the associated traffic type. A lowest score/value may indicate that the associated category is the least likely traffic category of the traffic flow, from among all of the possible traffic categories. These and other aspects of the present disclosure are discussed in greater detail below in connection with the examples of FIGS. 1-5.

To better understand the present disclosure, FIG. 1 illustrates an example system 100 (e.g., comprising one or more networks), related to the present disclosure. As shown in FIG. 1, the system 100 connects mobile devices 157A, 157B, 167A and 167B, and home network devices such as home gateway 161, set-top boxes (STBs) 162A and 162B, television (TV) 163A and TV 163B, phone 164, router 165, personal computer (PC) 166, and so forth, with one another and with various other devices via a telecommunication network 110, a wireless access network 150 (e.g., a cellular network), an access network 120, other networks 140, content distribution network (CDN) 170, and/or the Internet in general. For instance, connections between telecommunication network 110, access network 120, customer premises network 160 (e.g., a home network, an enterprise network, etc.), CDN 170, wireless access network 150 and other networks 140 may comprise the Internet in general, internal links under the control of single telecommunication service provider network, links between peer networks, and so forth.

In one example, wireless access network 150 may comprise a radio access network implementing such technologies as: Global System for Mobile Communication (GSM), e.g., a Base Station Subsystem (BSS), or IS-95, a Universal Mobile Telecommunications System (UMTS) network employing Wideband Code Division Multiple Access (WCDMA), or a CDMA3000 network, among others. In other words, wireless access network 150 may comprise an access network in accordance with any “second generation” (2G), “third generation” (3G), “fourth generation” (4G), Long Term Evolution (LTE), “fifth generation” (5G) or any other yet to be developed future wireless/cellular network technology. While the present disclosure is not limited to any particular type of wireless access network, in the illustrative example, wireless access network 150 is shown as a UMTS terrestrial radio access network (UTRAN) subsystem. Thus, elements 152 and 153 may each comprise a Node B or evolved Node B (eNodeB). In one example, wireless access network 150 may be controlled and/or operated by a same entity as telecommunication network 110.

In one example, each of the mobile devices 157A, 157B, 167A, and 167B may comprise any subscriber/customer endpoint device configured for wireless communication such as a laptop computer, a Wi-Fi device, a Personal Digital Assistant (PDA), a mobile phone, a smartphone, an email device, a computing tablet, a messaging device, and the like. In one example, any one or more of mobile devices 157A, 157B, 167A, and 167B may have both cellular and non-cellular access capabilities and may further have wired communication and networking capabilities.

As illustrated in FIG. 1, system 100 includes a telecommunication network 110. In one example, telecommunication network 110 may combine core network components of a cellular network with components of a triple play service network; where triple play services include telephone services, Internet services and television services to subscribers. For example, telecommunication network 110 may functionally comprise a fixed mobile convergence (FMC) network, e.g., an IP Multimedia Subsystem (IMS) network. In addition, telecommunication network 110 may functionally comprise a telephony network, e.g., an Internet Protocol/Multi-Protocol Label Switching (IP/MPLS) backbone network utilizing Session Initiation Protocol (SIP) for circuit-switched and Voice over Internet Protocol (VoIP) telephony services. Telecommunication network 110 may also further comprise a broadcast television network, e.g., a traditional cable provider network or an Internet Protocol Television (IPTV) network, as well as an Internet Service Provider (ISP) network. The network elements (NEs) 111A-111D (hereinafter individually referred to as a “network element 111” or collectively referred to as “network elements 111”) may serve as gateway servers or edge routers to interconnect the telecommunication network 110 with other networks 140, wireless access network 150, access network 120, and so forth. As shown in FIG. 1, telecommunication network 110 may also include a plurality of television (TV) servers 112, and a plurality of application servers 114.

With respect to television service provider functions, telecommunication network 110 may include one or more television servers 112 for the delivery of television content, e.g., a broadcast server, a cable head-end, and so forth. For example, telecommunication network 110 may comprise a video super hub office, a video hub office and/or a service office/central office. In this regard, television servers 112 may include content server(s) to store scheduled television broadcast content for a number of television channels, video-on-demand (VoD) programming, local programming content, and so forth. Alternatively, or in addition, content providers may stream various contents to the telecommunication network 110 for distribution to various subscribers, e.g., for live content, such as news programming, sporting events, and the like. Television servers 112 may also include advertising server(s) to store a number of advertisements that can be selected for presentation to viewers, e.g., in the customer premises network 160 and at other downstream viewing locations. For example, advertisers may upload various advertising content to the telecommunication network 110 to be distributed to various viewers. Television servers 112 may also include interactive TV/video-on-demand (VoD) server(s) and/or network-based digital video recorder (DVR) servers, as described in greater detail below.

In one example, the access network 120 may comprise a Digital Subscriber Line (DSL) network, a broadband cable access network, a Local Area Network (LAN), a cellular or wireless access network, a 3^{rd} party network, and the like. For example, the operator of telecommunication network 110 may provide a cable television service, an IPTV service, or any other types of television service to subscribers via access network 120. In this regard, access network 120 may include a node 122, e.g., a mini-fiber node (MFN), a video-ready access device (VRAD) or the like. However, in another example, node 122 may be omitted, e.g., for fiber-to-the-premises (FTTP) installations. Access network 120 may also transmit and receive communications between customer premises network 160 and telecommunication network 110 relating to voice telephone calls, communications with web servers via other networks 140, content distribution network (CDN) 170 and/or the Internet in general, and so forth. In another example, access network 120 may be operated by a different entity from telecommunication network 110, e.g., an Internet service provider (ISP) network.

Alternatively, or in addition, the system 100 may provide television services to customer premises network 160 via satellite broadcast. For instance, ground station 130 may receive television content from television servers 112 for uplink transmission to satellite 135. Accordingly, satellite 135 may receive television content from ground station 130 and may broadcast the television content to satellite receiver 139, e.g., a satellite link terrestrial antenna (including satellite dishes and antennas for downlink communications, or for both downlink and uplink communications), as well as to satellite receivers of other subscribers within a coverage area of satellite 135. In one example, satellite 135 may be controlled and/or operated by a same network service provider as the telecommunication network 110. In another example, satellite 135 may be controlled and/or operated by a different entity and may carry television broadcast signals on behalf of the telecommunication network 110.

As illustrated in FIG. 1, telecommunication network 110 may include various application servers 114. For instance, application servers 114 may be implemented to provide certain functions or features, e.g., a Serving-Call Session Control Function (S-CSCF), a Proxy-Call Session Control Function (P-CSCF), or an Interrogating-Call Session Control Function (I-CSCF), one or more billing servers for billing one or more services, including cellular data and telephony services, wire-line phone services, Internet access services, and television services. Application servers 114 may also include a Home Subscriber Server/Home Location Register (HSS/HLR) for tracking cellular subscriber device location and other functions. An HSS refers to a network element residing in the control plane of an IMS network that acts as a central repository of all customer specific authorizations, service profiles, preferences, etc. Application servers 114 may also include an IMS media server (MS) for handling and terminating media streams to provide services such as announcements, bridges, and Interactive Voice Response (IVR) messages for VoIP and cellular service applications. The MS may also interact with customers for media session management. In addition, application servers 114 may also include a presence server, e.g., for detecting a presence of a user. For example, the presence server may determine the physical location of a user or whether the user is “present” for the purpose of a subscribed service, e.g., online for a chatting service and the like. In one example, application servers 114 may include data storage servers to receive and store manifest files regarding adaptive bitrate streaming videos maintained within TV servers 112 and/or available to subscribers of telecommunication network 110 and stored in server(s) 149 in other networks 140. It should be noted that the foregoing are only several examples of the types of relevant application servers 114 that may be included in telecommunication network 110 for storing information relevant to providing various services to subscribers.

In one example, customer premises network 160 may include a gateway 161, which receives data/communications associated with different types of media, e.g., television, phone, and Internet, and separates these communications for the appropriate devices. The data/communications may be received via access network 120 and/or via satellite receiver 139, for instance. In one example, television data is forwarded to set-top boxes (STBs)/digital video recorders (DVRs) 162A and 162B to be decoded, recorded, and/or forwarded to television (TV) 163A and TV 163B for presentation. Similarly, telephone data is sent to and received from phone 164; Internet communications are sent to and received from router 165, which may be capable of both wired and/or wireless communication. In turn, router 165 receives data from and sends data to the appropriate devices, e.g., personal computer (PC) 166, mobile devices 167A, and 167B, and so forth. In one example, router 165 may further communicate with TV (broadly a display) 163A and/or 163B, e.g., where one or both of the televisions is a smart TV. In one example, router 165 may comprise a wired Ethernet router and/or an Institute for Electrical and Electronics Engineers (IEEE) 802.11 (Wi-Fi) router, and may communicate with respective devices in customer premises network 160 via wired and/or wireless connections. In accordance with the present discourse, Internet communications may include packets, or traffic flows, associated with one of several traffic categories, including: streaming video (e.g., “over-the-top” (OTT) video streaming provided by an operator of core network 110 and/or a third party, such as via server(s) 149, CDN 170, etc.), streaming audio, conversational video, conversational audio (e.g., VoIP, voice over LTE (VoLTE)), gaming, and/or other internet traffic, such as email, web browsing, system updates for PC 166, etc.

System 100 may also include a content distribution network (CDN) 170. In one example, CDN 170 may be operated by a different entity from telecommunication network 110. In another example, CDN 170 may be operated by a same entity as telecommunication network 110, e.g., a telecommunication service provider. In one example, the CDN 170 may comprise a collection of cache servers distributed across a large geographical area and organized in a tier structure. The first tier may comprise a group of servers that accesses content web servers (e.g., origin servers) to pull content into the CDN 170, referred to as an ingestion servers, e.g., ingest server 172. The content may include videos, content of various webpages, electronic documents, video games, etc. A last tier may comprise cache servers which deliver content to end user, referred to as edge caches, or edge servers, e.g., edge server 174. For ease of illustration, a single ingest server 172 and a single edge server 174 are shown in FIG. 1. In between the ingest server 172 and edge server 174, there may be several layers of servers (omitted from the illustrations), referred to as the middle tier. In one example, the edge server 174 may be multi-tenant, serving multiple content providers, such as telecommunication network 110, content providers associated with server(s) 149 in other network(s) 140, and so forth. In one example, edge server 174 may comprise an adaptive bitrate streaming video server.

In accordance with the present disclosure, one or more of the network elements 111 may function as a classifier for classifying data traffic flows that traverse the system 100. For instance, the network element 111A may obtain a copy of a traffic flow (e.g., one or more “storage records,” or “flow records”) and/or may copy packets of the traffic flow into at least one storage record (e.g., for packets and/or traffic flows comprising packets that traverse network element 111A). In one example, network element 111A may assign packets to the traffic flow (e.g., from among all packets traversing network element 111A) based upon at least a source IP address and a destination IP address. In one example, network element 111A may assign packets to the traffic flow based upon a 5-tuple. In one example, network element 111A may further determine a transport layer protocol utilized by the traffic flow and/or an average throughput of the traffic flow. For instance, a traffic flow may be defined for a streaming video that is streamed from one of servers 149 to PC 166, e.g., based upon an IP address of the one of the servers 149 and an IP address of PC 166 (and/or an IP address of the home gateway 161). In one example, the traffic flow may be further defined in accordance with a source port, a destination port, and a transport layer protocol (e.g., TCP or UDP).

In one example, network element 111A may additionally generate a binary traffic vector for the traffic flow, e.g., as described above, and apply a traffic flow record comprising the binary traffic vector (and in one example, the transport layer protocol and/or the average throughput) as an input, or inputs to a deep learning classifier that is trained to classify traffic flow records into one of a plurality of traffic categories (e.g., a CNN-based deep learning classifier). In such an example, the network element 111A may then determine a traffic category of the traffic flow based upon an output of the deep learning classifier (e.g., the traffic category with the highest output value/score).

In one example, network element 111A may train the deep learning classifier, e.g., by obtaining training data comprising labeled traffic flow records comprising binary traffic vectors (and in some cases, transport layer protocol and/or average throughput information) for traffic flows of known traffic types and applying the training data to the deep learning classifier. In another example, the deep learning classifier may be trained by another device or processing system (such as one or more of application servers 114) and may be provided to network element 111A. In one example, network element 111A may provide a classification result to one or more other components of system 100, e.g., to one of application servers 114. Alternatively, or in addition, network element 111A may provide a report of overall traffic statistics for all traffic categories and/or for at least one of the traffic categories (e.g., an overall percentage of data traffic of a particular traffic category, or for each traffic category) for traffic flows processed via network element 111A (e.g., within a given time period, such as an hourly report, a daily report, etc.).

In one example, network element 111A may further perform optimizations of the system 100 based on the resulting traffic classification(s). For instance, the network element 111A may allocate at least one additional resource of the system 100 and/or remove at least one existing resource of the system 100 based upon the traffic category of the traffic flow that is determined (or based upon traffic categories that are determined for multiple traffic flows via the network element 111A over a time period). Alternatively, or in addition, another component of the system 100 may obtain the classification result(s) for one or more traffic flows and/or one or more traffic flow categorization reports from network element 111A, and may implement similar optimizations to the system 100 in response thereto. For example, an additional resource that may be added or an existing resource that may be removed (e.g., deactivated and/or deallocated) may be a hardware component, or may be provided by hardware, e.g., bandwidth on a link, line card, router, switch, or other processing nodes, a CDN storage resource, a virtual machine (VM) and/or a virtual network function (VNF), etc.

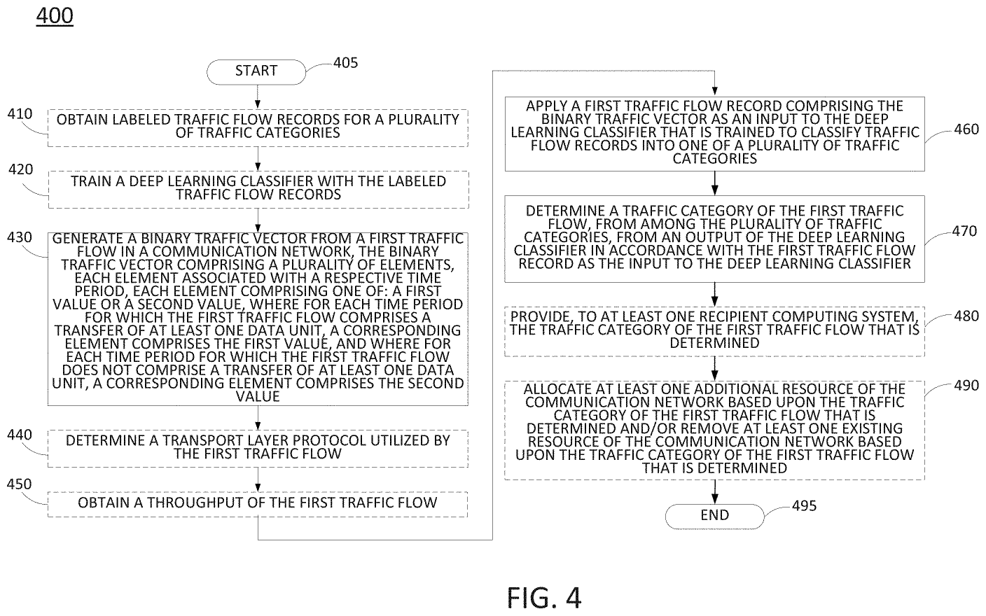

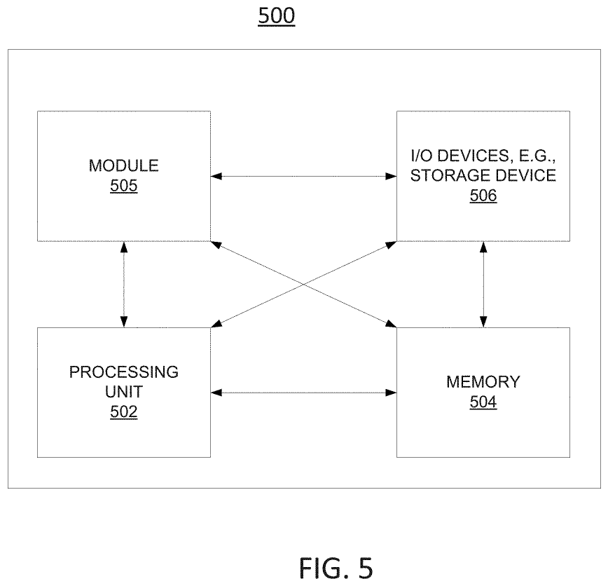

In one example, a network element 111 functioning as a classifier may comprise all or a portion of a computing system, such as computing system 500 as depicted in FIG. 5, and may be configured to provide one or more functions in connection with examples of the present disclosure for determining a traffic category via a deep learning classifier based upon a traffic vector generated from a traffic flow. For instance, an example method 400 for determining a traffic category via a deep learning classifier based upon a traffic vector generated from a traffic flow is illustrated in FIG. 4 and described in greater detail below.

It should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device including one or more processors, or cores (e.g., as illustrated in FIG. 5 and discussed below) or multiple computing devices collectively configured to perform various steps, functions, and/or operations in accordance with the present disclosure.

It should be noted that the system 100 may be implemented in a different form than that which is illustrated in FIG. 1, or may be expanded by including additional endpoint devices, access networks, network elements, application servers, etc. without altering the scope of the present disclosure. For example, telecommunication network 110 is not limited to an IMS network. Wireless access network 150 is not limited to a UMTS/UTRAN configuration. Similarly, the present disclosure is not limited to an IP/MPLS network for VoIP telephony services, or any particular type of broadcast television network for providing television services, and so forth.

In one example, operations or functions described in connection with network element 111A may alternatively or additionally be performed and/or be provided by one or more other components of the system 100, such as a different one or more of network elements 111B-111D, one or more of application servers 114, edge server 174 and/or ingest server 172, and so forth. As such, any one or more of such devices may also comprise all or a portion of a computing system, such as computing system 500 as depicted in FIG. 5, and may be configured to provide one or more functions in connection with examples of the present disclosure for determining a traffic category via a deep learning classifier based upon a traffic vector generated from a traffic flow. As noted above, in one example, a deep learning classifier may be trained by another device or processing system (such as one or more of application servers 114) and may be provided to network element 111A. In addition, in one example, the same trained deep learning classifier may be provided to other network nodes for implementation in a similar manner (e.g., network elements 111B-111D). However, in another example, different deep learning classifiers may be trained for different network nodes. For instance, there may be regional differences in the traffic patterns of different traffic flows types that may be captured in the training data and that may be used to train deep learning classifiers that are specifically tuned for the different regions. In addition, as noted above, in other, further, and different examples, a different type of traffic vector may be used to characterize a traffic flow (such as a ternary-based vector, a quaternary-based vector, etc.). In such an example, a deep learning classifier may also be trained in accordance with training data comprising such ternary-based or quaternary-based traffic vectors, and so on. Thus, these and other modifications are all contemplated within the scope of the present disclosure.

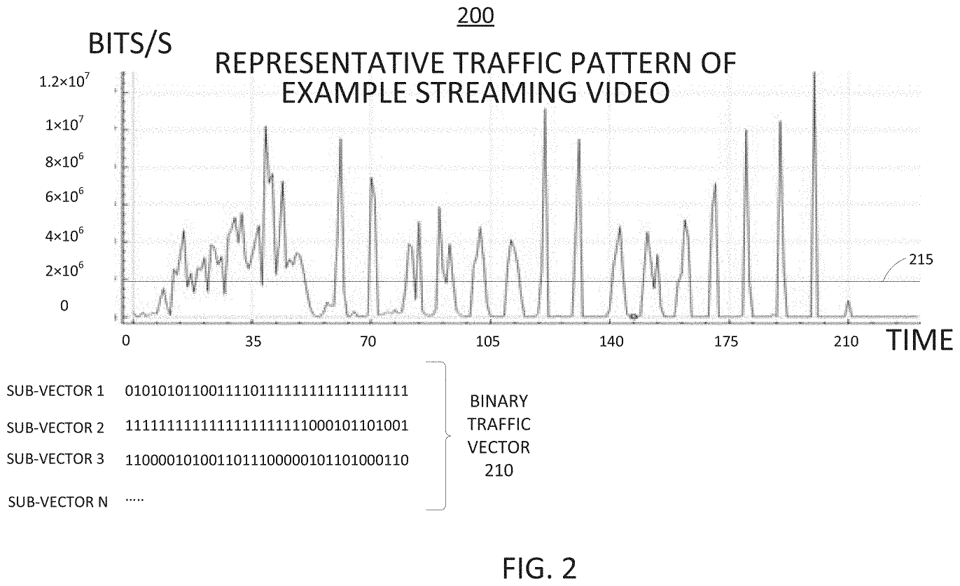

To further aid in understanding the present disclosure, FIG. 2 illustrates a graph 200 of a representative traffic pattern of an example streaming video and a corresponding example binary traffic vector 210. As can be seen in FIG. 2, for this example traffic flow, the bitrate ranges from zero (0) to around 1.2×10⁷ over the course of 210 seconds. For illustrative purposes, it may be assumed that this particular traffic flow ends at or around 210 seconds. The average throughput, or average bitrate 215 is also labeled in FIG. 2, and is approximately 1.8×10⁶ bits/second (b/s). As described above, a binary traffic vector may be created for a traffic flow for further processing as an input to a deep learning classifier. In the present example, the binary traffic vector 210 may be generated from the traffic flow associated with the graph 200. In addition, as noted above, a binary traffic vector, such as binary traffic vector 210 may be segmented into different records. In addition, a given record may include a number of sub-vectors of a given binary traffic vector. For instance, FIG. 2 illustrates an example of 35-second sub-vectors. For the entire traffic flow associated with graph 210 (which is just over 210 seconds), the corresponding binary traffic vector may include seven 35-second sub-vectors (which for illustrative purposes are shown as sub-vectors 1 through N in FIG. 2). Notably, each of the sub-vectors comprises 35 elements (e.g., one for each second time slot), each element comprising a zero (0), indicating the absence of any packets for the traffic flow, or a one (1), indicating the presence of at least one packet of the packet flow, respectively.

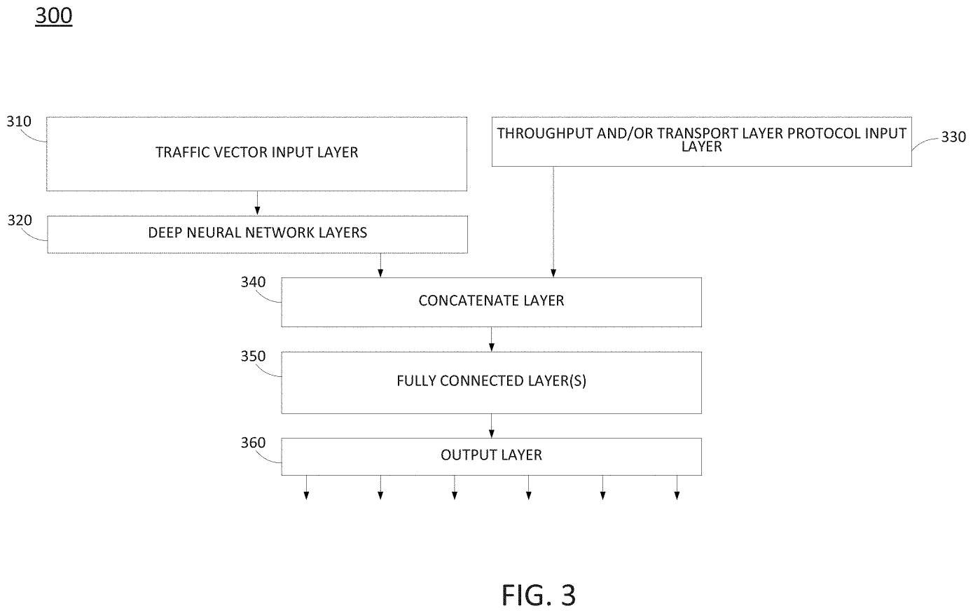

FIG. 3 illustrates an example architecture of a deep learning classifier 300 (e.g., a convolutional neural network (CNN)-based classifier), in accordance with the present disclosure. In one example, at least one binary traffic vector of a traffic flow may be input (e.g., via traffic vector input layer 310) to a plurality of layers of a deep neural network (deep neural network layers 320). In accordance with the present disclosure, the deep neural network layers 320 may comprise a CNN, such as AlexNet, WaveNet, or the like. For instance, WaveNet is primarily used for voice recognition, while traditionally a CNN is more symmetric and suitable for image matching. However, WaveNet combines aspects of prior CNNs with the ability and features to handle time series data. Notably, a binary traffic vector of a traffic flow may appear symmetric. Nevertheless, in the time domain there is some information, and thus constitutes a time series. For example, if there is an issue at the beginning of video streaming, the rate may be low, but then the rate may go significantly higher to catch up. In any case, it should be noted that various examples of the present disclosure may utilize any type of CNN for the deep neural network layers 320.

In the example of FIG. 3, a concatenate layer 340 may join an output of the deep neural network layers 330 with the additional input(s) of the transport layer protocol and/or the average throughput (that may be input via the throughput and/or transport layer protocol input layer 330). One or more fully-connected layers 350 may follow the concatenate layer 340. Lastly, an output layer 360 coupled to the fully-connected layer(s) 350 may provide outputs comprising values/scores for each of the possible traffic categories (e.g., six traffic categories, such as noted above). For instance, each value/score may provide a relative likelihood or confidence that a particular traffic flows belongs/does not belong to each category. For example, a highest score/value may indicate that a traffic flow most likely is of the associated traffic type/traffic category. A lowest score/value may indicate that the associated category is the least likely traffic category of the traffic flow, from among all of the possible traffic categories.

As also noted above, labeled traffic flow records comprising binary traffic vectors (and in some cases, transport layer protocol and/or average throughput information) for traffic flows of known traffic types may be obtained and utilized as training data to train the deep learning classifier 300. In one example, the deep learning classifier 300 may further be tuned in accordance with one or more “hyperparameters,” such as batch size, learning rate, number of epochs, number of nodes/units (neurons), dropout probability, neuron weights, tensor shape, convolutional kernel width and height, number of input channels, number of filters, filter shape, maximum number of parameters for one or more layers, and so forth. Tunable hyperparameters of deep learning classifier 300 may also include a number of layers of the deep neural network layers 320 (e.g., a number of hidden layers), a number of fully-connected layers 350, and so on. In one example, the hyperparameters may be tuned to balance a speed of training with an accuracy of classification, a speed of classification with an accuracy of classification, etc. For example, other/existing approaches to traffic classification may first capture large amounts of traffic flow data and then calculate throughput, bitrate, etc. However, while the traffic vectors (e.g., binary traffic vectors) of the present disclosure may be similarly determined, the current approach can also be embedded in network nodes, such as gateways, routers, firewalls, etc., with traffic vectors being generated on-the-fly and with classification decisions being made (such as via deep learning classifier 300) in real-time or near-real-time. In this regard, it should be noted that in one example, the deep learning classifier 300 may be trained on labeled training data comprising traffic vectors representing less than all of a traffic flow (e.g., at most two minutes, at most 10 minutes, etc.). In particular, it may be determined that the classification accuracy is acceptable while using traffic vectors of a designated maximum length, such that classification decisions via the deep learning classifier 300 may be made with traffic vectors representing at most X minutes (or other time duration) of traffic flows.

It should also be noted that although the present disclosure is described primarily in connection with the abovementioned six traffic categories, in one example, the present disclosure may alternatively or additionally classify into one or more sub-categories from these main categories, such as classifying a traffic flow as being of a particular streaming audio service provider as compared to one or more other streaming audio service providers, as being of a particular video conferencing service provider as compared to one or more other video conferencing service providers, and so forth. In such case, the output layer 360 may include additional outputs having respective values/scores associated with such alternative and/or additional traffic categories. Thus, these and other modifications are all contemplated within the scope of the present disclosure.

To further aid in understanding the present disclosure, FIG. 4 illustrates a flowchart of an example method 400 for determining a traffic category via a deep learning classifier based upon a traffic vector generated from a traffic flow. In one example, steps, functions and/or operations of the method 400 may be performed by a device as illustrated in FIG. 1, e.g., a network element (such as a gateway, a proxy, a firewall, etc.), an application server, an edge server or ingress server of a CDN, or the like, or any one or more components thereof, such as a processing system, or collectively via a plurality devices in FIG. 1, such as a network element in conjunction with an application server, and so forth. In one example, the steps, functions, or operations of method 400 may be performed by a computing device or system 500, and/or a processing system 502 as described in connection with FIG. 5 below. For instance, the computing device or system 500 may represent at least a portion of a network element, application server, ingress or egress/edge server, etc. that is configured to perform the steps, functions and/or operations of the method 400. Similarly, in one example, the steps, functions, or operations of method 400 may be performed by a processing system comprising one or more computing devices collectively configured to perform various steps, functions, and/or operations of the method 400. For instance, multiple instances of the computing device or system 500 may collectively function as a processing system. For illustrative purposes, the method 400 is described in greater detail below in connection with an example performed by a processing system, such as processing system 502. The method 400 begins in step 405 and may proceed to optional step 410 or to step 430.

At optional step 410, the processing system (e.g., deployed in a communication network) may obtain labeled traffic flow records for a plurality of traffic categories. For instance, the labeled traffic flow records may comprise respective binary traffic vectors for various traffic flows of known traffic types. In one example, each labeled traffic flow record may further include one or both of a respective transport layer protocol of an associated traffic flow or an average throughput of the associated traffic flow.

At optional step 420, the processing system may train the deep learning classifier with the labeled traffic flow records that may be obtained at optional step 410. For instance, as noted above, the deep learning classifier may comprise a deep neural network. In one example, the deep neural network may comprise a convolutional neural network (CNN), such as a WaveNet, an AlexNet, or the like. In one example, the deep neural network is to process binary traffic vectors, such as described above in connection with the example of FIG. 3. In examples in which the one or more additional inputs are utilized, the deep learning classifier may further comprise a concatenate layer to concatenate an output vector of the deep neural network (e.g., the CNN) with the one or more additional inputs (e.g., the average throughput and/or the transport layer protocol). As also noted above in connection with the example of FIG. 3, the deep learning classifier may further comprise a plurality of fully-connected layers fed by the concatenate layer, and an output layer fed by the plurality of fully-connected layers. For instance, the output layer may provide a plurality of output scores, each of the plurality of output scores associated with one of the plurality of traffic categories. For instance, the plurality of traffic categories may comprise: streaming video, streaming audio, conversational video, conversational audio, gaming, and other (e.g., all other types of web browsing traffic).

At step 430, the processing system generates a binary traffic vector from a first traffic flow in the communication network. In one example, the binary traffic vector comprises a plurality of elements, each of the plurality of elements associated with a respective time period. For instance, each of the plurality of elements may comprise one of: a first value or a second value (e.g., a one (1) or a zero (0)), wherein for each respective time period for which the first traffic flow comprises a transfer of at least one data unit (e.g., a packet), a corresponding element of the plurality of elements comprises the first value (e.g., a one (1)), and wherein for each respective time period for which the first traffic flow does not comprise a transfer of at least one data unit, a corresponding element of the plurality of elements comprises the second value (e.g., a zero (0)).

In one example, step 430 may further include obtaining a copy of the first traffic flow (e.g., a flow record, where the “generating” is from the copy of the first traffic flow), or copying packets of the first traffic flow into at least one flow record, e.g., a storage record for the first traffic flow. In one example, a flow record may comprise sampled packets, or may be non-sampled (i.e., the full set). In one example, the first traffic flow may have multiple storage records, e.g., one per each 60 seconds of the traffic flow, etc. In one example, step 430 may involve obtaining summary statistics of the first traffic flow (such as a throughput/bitrate for each time period), and generating the binary traffic vector from the summary statistics. As noted above, the processing system may represent a network firewall or an ingress/egress node of the communication network, e.g., a proxy, a gateway, a CDN edge server, a CDN ingress server, etc. In one example, the binary traffic vector is generated as the packets of the first traffic flow are processed via such a network node. In one example, packets processed via the communication network (e.g., in one example traversing a network node comprising the processing system) are assigned to the first traffic flow based upon a 5-tuple comprising a source IP address, a destination IP address, a source port, a destination port, and a transport layer protocol.

At optional step 440, the processing system may determine a transport layer protocol utilized by the first traffic flow. For instance, even where SNI is encrypted in an IP header, the transport layer protocol may still be visible to the communication network to enable proper routing and other handling of packets of the traffic flow (e.g., confirming delivery, resending, etc.). For instance, in one example, the transport layer protocol may be determined between TCP and UDP.

At optional step 450, the processing system may obtain a throughput of the first traffic flow. For instance, the average throughput, or average bitrate may be monitored and recorded for traffic flows, including at least the first traffic flow, traversing a network node (e.g., a network node comprising the processing system).

At step 460, the processing system applies a first traffic flow record comprising the binary traffic vector as an input to a deep learning classifier that is trained to classify traffic flow records into one of a plurality of traffic categories. For instance, the deep learning classifier may be of the same or similar nature a described above in connection with optional step 420 and/or as described elsewhere herein. In one example, the first traffic flow record further comprises at least one of the throughput or the transport layer protocol that may be determined at optional steps 440 and/or 450, respectively. In one example, the deep learning classifier is trained by/via the processing system. In another example, the deep learning classifier may be trained by/via another device and/or processing system, and provided to the processing system performing the method 400 for deployment and use.

At step 470, the processing system determines a traffic category of the first traffic flow, from among the plurality of traffic categories, from an output of the deep learning classifier in accordance with the first traffic flow record as the input to the deep learning classifier. For instance, the traffic category of the first traffic flow may be determined from a highest output score from among the plurality of output scores of an output layer of the deep learning classifier. For example, the traffic category may be determined as one of: streaming video, streaming audio, conversational video, conversational audio, gaming, or “other” (e.g., not part of any other specified categories).

At optional step 480, the processing system may provide, to at least one recipient computing system, the traffic category of the first traffic flow that is determined. For instance, the method 400 may be performed by a processing system of a network node that routes network traffic, whereas analysis of reports, trends, etc. and any actions that may be implemented responsive thereto may take place via one or more other devices or systems, such as personnel devices of an operator of the communication network, a software defined network (SDN) controller, a self-optimizing network (SON) orchestrator, or the like, and so forth.

At optional step 490, the processing system may allocate at least one additional resource of the communication network based upon the traffic category of the first traffic flow that is determined and/or may remove at least one existing resource of the communication network based upon the traffic category of the first traffic flow that is determined. In one embodiment, the processing system may reconfigure at least one allocated resource of the communication network differently based upon the traffic category of the first traffic flow that is determined, i.e., without having to allocate a new resource of the communication network. For instance, optional step 490 may be performed in accordance with a network traffic report, or reports, that give(s) a percentage and/or volume of traffic for a particular traffic category, or for some or all of the plurality of traffic categories. In addition, such network traffic report(s) can be for a particular portion of the communication network, can be over a particular reporting time period, etc. In accordance with optional step 490, an additional resource that may be added or an existing resource that may be removed (e.g., deactivated and/or deallocated) may be a hardware component, or may be provided by hardware, e.g., bandwidth on a link, line card, router, switch, or other processing node, a CDN storage resource, a VM and/or a VNF, etc.

Following step 470, or any one of optional steps 480 and/or 490, the method 400 proceeds to step 495. At step 495, the method 400 ends.

It should be noted that the method 400 may be expanded to include additional steps or may be modified to include additional operations with respect to the steps outlined above. For example, the method 400 may be repeated for one or more additional traffic flows, may be repeated for additional training and/or retraining of the deep learning classifier, and so forth. In one example, the method 400 may be expanded to include tuning hyperparameters of the deep learning classifier, and so forth. Alternatively, or in addition, in one example, the method 400 may comprise training a deep learning classifier, generating a traffic vector, applying a traffic flow record comprising the traffic vector to the deep learning classifier, determining a traffic category, and so forth with regard to a ternary-based traffic vector, a quaternary-based traffic vector, etc. Thus, these and other modifications are all contemplated within the scope of the present disclosure.

In addition, although not specifically specified, one or more steps, functions, or operations of the method 400 may include a storing, displaying, and/or outputting step as required for a particular application. In other words, any data, records, fields, and/or intermediate results discussed in the method can be stored, displayed, and/or outputted either on the device executing the method or to another device, as required for a particular application. Furthermore, steps, blocks, functions or operations in FIG. 4 that recite a determining operation or involve a decision do not necessarily require that both branches of the determining operation be practiced. In other words, one of the branches of the determining operation can be deemed as an optional step. Furthermore, steps, blocks, functions or operations of the above described method can be combined, separated, and/or performed in a different order from that described above, without departing from the examples of the present disclosure.

FIG. 5 depicts a high-level block diagram of a computing device or computing system 500 specifically programmed to perform the functions described herein. For example, any one or more components or devices illustrated in FIG. 1, or described in connection with the examples of FIGS. 2-4 may be implemented as the computing system 500. As depicted in FIG. 5, the computing system 500 comprises one or more hardware processor elements 502 (e.g., a microprocessor, a central processing unit (CPU) and the like), a memory 504, (e.g., random access memory (RAM), read only memory (ROM), a disk drive, an optical drive, a magnetic drive, and/or a Universal Serial Bus (USB) drive), a module 505 for determining a traffic category via a deep learning classifier based upon a traffic vector generated from a traffic flow, and various input/output devices 506, e.g., a camera, a video camera, storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like).

Although only one processor element is shown, it should be noted that the computing device may employ a plurality of processor elements. Furthermore, although only one computing device is shown in the Figure, if the method(s) as discussed above is implemented in a distributed or parallel manner for a particular illustrative example, i.e., the steps of the above method(s) or the entire method(s) are implemented across multiple or parallel computing devices, e.g., a processing system, then the computing device of this Figure is intended to represent each of those multiple general-purpose computers. Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented. The hardware processor 502 can also be configured or programmed to cause other devices to perform one or more operations as discussed above. In other words, the hardware processor 502 may serve the function of a central controller directing other devices to perform the one or more operations as discussed above.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a computing device, or any other hardware equivalents, e.g., computer readable instructions pertaining to the method(s) discussed above can be used to configure a hardware processor to perform the steps, functions and/or operations of the above disclosed method(s). In one example, instructions and data for the present module or process 505 for determining a traffic category via a deep learning classifier based upon a traffic vector generated from a traffic flow (e.g., a software program comprising computer-executable instructions) can be loaded into memory 504 and executed by hardware processor element 502 to implement the steps, functions or operations as discussed above in connection with the example method 400. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method(s) can be perceived as a programmed processor or a specialized processor. As such, the present module 505 for determining a traffic category via a deep learning classifier based upon a traffic vector generated from a traffic flow (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. Furthermore, a “tangible” computer-readable storage device or medium comprises a physical device, a hardware device, or a device that is discernible by the touch. More specifically, the computer-readable storage device may comprise any physical devices that provide the ability to store information such as data and/or instructions to be accessed by a processor or a computing device such as a computer or an application server.

While various embodiments have been described above, it should be understood that they have been presented by way of example only, and not limitation. Thus, the breadth and scope of a preferred embodiment should not be limited by any of the above-described example embodiments, but should be defined only in accordance with the following claims and their equivalents.

What is claimed is:

1. A method, comprising:
generating, by a processing system including at least one processor, a binary traffic vector from a first traffic flow in a communication network, wherein the binary traffic vector comprises a plurality of elements, each of the plurality of elements associated with a respective time period, each of the plurality of elements comprising one of: a first value or a second value, wherein for each respective time period for which the first traffic flow comprises a transfer of at least one data unit, a corresponding element of the plurality of elements comprises the first value, and wherein for each respective time period for which the first traffic flow does not comprise a transfer of at least one data unit, a corresponding element of the plurality of elements comprises the second value;
applying, by the processing system, a first traffic flow record comprising the binary traffic vector as an input to a deep learning classifier that is trained to classify traffic flow records into one of a plurality of traffic categories; and
determining, by the processing system, a traffic category of the first traffic flow, from among the plurality of traffic categories, from an output of the deep learning classifier in accordance with the first traffic flow record as the input to the deep learning classifier.

2. The method of claim 1, further comprising:
providing, to at least one recipient computing system, the traffic category of the first traffic flow that is determined.

3. The method of claim 1, further comprising at least one of:
allocating at least one additional resource of the communication network based upon the traffic category of the first traffic flow that is determined; or
removing at least one existing resource of the communication network based upon the traffic category of the first traffic flow that is determined.

4. The method of claim 1, wherein the plurality of traffic categories comprises at least two of:
a streaming video category, a streaming audio category, a conversational video category, a conversational audio category, and a gaming category.

5. The method of claim 1, wherein the generating the binary traffic vector comprises:
obtaining a copy of the first traffic flow; or
copying packets of the first traffic flow into at least one storage record for the first traffic flow.

6. The method of claim 1, wherein the binary traffic vector is generated as packets of the first traffic flow are processed via:
a network firewall; or
an ingress/egress node of the communication network.

7. The method of claim 1, wherein packets processed via the communication network are assigned to the first traffic flow based upon a 5-tuple comprising a source internet protocol address, a destination internet protocol address, a source port, a destination port, and a transport layer protocol.

8. The method of claim 1, further comprising:
determining a transport layer protocol utilized by the first traffic flow, wherein the first traffic flow record further comprises the transport layer protocol.

9. The method of claim 8, wherein the transport layer protocol is determined from among a transport control protocol and a uniform data protocol.

10. The method of claim 1, further comprising:
obtaining a throughput of the first traffic flow and a transport layer protocol utilized by the first traffic flow, wherein the first traffic flow record further comprises at least one of the throughput or the transport layer protocol.

11. The method of claim 1, further comprising:
obtaining labeled traffic flow records for the plurality of traffic categories; and
training the deep learning classifier with the labeled traffic flow records.

12. The method of claim 1, wherein the deep learning classifier comprises:
a convolutional neural network.

13. The method of claim 12, wherein the convolutional neural network comprises:
a wavenet neural network; or
an alexnet neural network.

14. The method of claim 12, wherein the convolutional neural network comprises a deep neural network to process the binary traffic vector.

15. The method of claim 14, further comprising at least one of:
determining a transport layer protocol utilized by the first traffic flow; or
obtaining a throughput of the first traffic flow.

16. The method of claim 15, wherein the deep learning classifier further comprises a concatenate layer to concatenate an output vector of the deep neural network with at least one additional input comprising at least one of:
the throughput of the first traffic flow; or
the transport layer protocol of the first traffic flow.

17. The method of claim 16, wherein the deep learning classifier further comprises a plurality of fully-connected layers fed by the concatenate layer, and an output layer fed by the plurality of fully-connected layers.

18. The method of claim 17, wherein the output layer provides a plurality of output scores, each of the plurality of output scores associated with one of the plurality of traffic categories, wherein the traffic category of the first traffic flow is determined from a highest output score from among the plurality of output scores.

19. A non-transitory computer-readable medium storing instructions which, when executed by a processing system of an endpoint device including at least one processor, cause the processing system to perform operations, the operations comprising:
generating a binary traffic vector from a first traffic flow in a communication network, wherein the binary traffic vector comprises a plurality of elements, each of the plurality of elements associated with a respective time period, each of the plurality of elements comprising one of: a first value or a second value, wherein for each respective time period for which the first traffic flow comprises a transfer of at least one data unit, a corresponding element of the plurality of elements comprises the first value, and wherein for each respective time period for which the first traffic flow does not comprise a transfer of at least one data unit, a corresponding element of the plurality of elements comprises the second value;
applying a first traffic flow record comprising the binary traffic vector as an input to a deep learning classifier that is trained to classify traffic flow records into one of a plurality of traffic categories; and
determining a traffic category of the first traffic flow, from among the plurality of traffic categories, from an output of the deep learning classifier in accordance with the first traffic flow record as the input to the deep learning classifier.

20. An apparatus comprising:
a processing system including at least one processor; and
a non-transitory computer-readable medium storing instructions which, when executed by the processing system, cause the processing system to perform operations, the operations comprising:
generating a binary traffic vector from a first traffic flow in a communication network, wherein the binary traffic vector comprises a plurality of elements, each of the plurality of elements associated with a respective time period, each of the plurality of elements comprising one of: a first value or a second value, wherein for each respective time period for which the first traffic flow comprises a transfer of at least one data unit, a corresponding element of the plurality of elements comprises the first value, and wherein for each respective time period for which the first traffic flow does not comprise a transfer of at least one data unit, a corresponding element of the plurality of elements comprises the second value;
applying a first traffic flow record comprising the binary traffic vector as an input to a deep learning classifier that is trained to classify traffic flow records into one of a plurality of traffic categories; and
determining a traffic category of the first traffic flow, from among the plurality of traffic categories, from an output of the deep learning classifier in accordance with the first traffic flow record as the input to the deep learning classifier.
